(19) United States
(12) Patent Application Publication
(10) Pub. No.: US 2015/0301537 A1
(43) Pub. Date: Oct. 22, 2015

(54) THERMOSTATIC ASSEMBLE AND MANUFACTURING METHOD THEREFOR

(71) Applicant: GLOBE UNION INDUSTRIAL CORP., Taiwan (CN)

(72) Inventors: Chu-Wan Hong, Taipei City (TW); Peng-Nien Tsai, Taichung City (TW)

(73) Assignee: GLOBE UNION INDUSTRIAL CORP, Taichung City (TW)

(21) Appl. No.: 14/439,318

(22) PCT Filed: Jul. 10, 2013
(86) PCT No.: PCT/CN2013/079129

§ 371 Date: Apr. 29, 2015

(30) Foreign Application Priority Data
Jan. 5, 2013 (CN) 201310002399.2

(51) Int. Cl. G05D 23/02; B23P 15/00; G01K 5/44

(52) U.S. Cl. CPC G05D 23/021; G01K 5/44; B23P 15/001

(57) ABSTRACT

A thermostatic assembly (c) and a manufacturing method therefor. The thermostatic assembly (c) comprises a metal casing (30), a housing (40), a heat sensitive material (50), a diaphragm (60) and a piston (70). A metal structural body (301) is formed in a chamber (34) of the metal casing (30), and the metal structural body (301) comprises countless granular metal powders (35), and countless cavities (36) mutually communicating with one another. The metal powders (35) are mutually consolidated with one another, and the metal powders (35) located at a peripheral position are mutually consolidated with the inner wall surface (37) of the metal casing (30). The cavities (36) are defined by gaps naturally formed among the metal powders (35), and between the inner wall surface (37) of the metal casing (30) and each adjacent metal powder (35). The heat sensitive material (50) is filled and injected into the cavities (36) in the form of a liquid. Through the design of using an integrally sintered metal structural body (301) and filling the heat sensitive material (50) into the cavities (36), heat conduction efficiency can be greatly improved, thereby shortening the reaction time of the thermostatic assembly (c).

### FIELD OF THE INVENTION

The present invention relates to a thermostatic assembly and a manufacturing method therefor which expands and contracts the thermostatic assembly with a change of a mixed temperature of cold water and hot water to control a water supply at a set temperature.

### BACKGROUND OF THE INVENTION

A conventional thermostatic assembly expands and contracts with a temperature change of fluid, such as water, and it is applied in a thermostatic controlling device or a thermostatic control valve of shower equipment so that a water supply is controlled at a set temperature.

As shown in FIGS. 1 and 2, another conventional thermostatic assembly disclosed in CN Publication No. 101084477A contains a metal casing 1, a housing 2, a heat sensitive material 3, a diaphragm 4, a piston 5, a wind box 6, a rubber pad 7, and a washer 8. The metal casing 1 further includes a tubular section 11, a bottom end 12 for closing the tubular section 11, and a loop 13 extending outwardly from a first end of the tubular section 11. The housing 2 includes a central channel 21 and a seat 22 fixed in the loop 13. The heat sensitive material 3 is paraffin wax filled in the tubular section 11 of the metal casing 1 and expands and contracts with a temperature change. The diaphragm 4 is disposed between the seat 22 of the housing 2 and the tubular section 11 to separate the seat 22 of the housing 2 from the heat sensitive material 3. The piston 5 is mounted in the central channel 21 of the housing 2 and is driven by a central area of the diaphragm 4. The piston 5 has a first end opposite to the diaphragm 4 and has a second end extending out of the housing 2 based on the temperature change and a volume change of the heat sensitive material 3. The wind box 6 is driven by the piston 5 to move without deformation. The central area of the diaphragm 4 drives the piston 5 via the rubber pad 7 and the washer 8 so that the piston 5 moves along an axial line X-X of the conventional thermostatic assembly. The rubber pad 7 is made of a flexible deformable elastomer and contacts with the diaphragm 4. The pad 8 is located between the piston 5 and the rubber pad 7 and is made of polymer, such as Teflon (PTFE) to prevent the rubber pad 7 from bending around the piston 5.

The heat sensitive material 3 of the conventional thermostatic assembly a is made of paraffin wax to drive the piston 5 to move, but a thermal conductivity coefficient of the paraffin wax is low, so when the metal casing 1 soaks in a fluid, such as water, a reaction delay happens without reacting the temperature change. To improve such a problem, heat conductive powders, such as copper powders or silver powders, are added into the paraffin wax. However, a heterogeneous mixture of the paraffin wax and the metal powders has a physical difference, and uniformity of the heterogeneous mixture affects the performance of the thermostatic assembly so the paraffin wax and the metal powders have to be mixed evenly. In case the paraffin wax and the metal powders are mixed unevenly, respective thermostatic assemblies have different performances. In addition, a density of the paraffin wax is about 0.8 g/cm³ greatly different from that of metal powders (for example, a density of the cooper powders is 8.94 g/cm³). Accordingly, in operation, a separated deposition of the copper powders occurs, and heat conductions and expansions and contractions of an upper end and the lower end of the heat sensitive material in the metal casing are different, thus reducing service life of the conventional thermostatic assembly.

To overcome above-mentioned problem, the conventional thermostatic assembly, as illustrated in FIGS. 3 and 4, has an improved metal casing 1. The metal casing 1 has at least two cavities 14 (i.e., four cavities 14) to fill the heat sensitive material 3, and the four cavities 14 connect with each other and the metal casing 1 so that external fluid or a temperature change of the water conducts heat toward the heat sensitive material 3 in the four cavities 14 through the metal casing 1. Taking the heat sensitive material 3 at a fixed volume and the metal casing 1 at a fixed length for example, a contacting area of the heat sensitive material 3 and the four cavities 14 is increased, and a largest distance between any two particles of the paraffin wax is lowered so as to enhance heat conducting efficiency and to reduce reaction time of the thermostatic assembly.

Nevertheless, the four cavities 14 of the metal casing 1 cannot contact with the external fluid directly, so the heat conducting efficiency is not improved greatly.

The present invention has arisen to mitigate and/or obviate the afore-described disadvantages.

### SUMMARY OF THE INVENTION

The primary object of the present invention is to provide a thermostatic assembly and a manufacturing method therefor which expand and contract the thermostatic assembly with a change of a mixed temperature of cold water and hot water to control a water supply at a set temperature.

To obtain the above objective, a thermostatic assembly provided by the present invention contains: a metal casing, a housing, a thermal reaction material, a diaphragm, and a piston.

The metal casing is soaked in a fluid, and the metal casing includes a tubular section, a bottom segment for closing the tubular section, an accommodating portion extending outwardly from a top end of the tubular section, and a chamber defined between the tubular section and the bottom segment.

The housing includes a central channel and a seat located at a bottom end thereof, wherein the seat is fixed in the accommodating portion of the metal casing.

The heat sensitive material is filled in the chamber of the metal casing and expands and contracts based on a mixed temperature of cold water and hot water.

The diaphragm is disposed between the housing and the metal casing to separate the housing from the heat sensitive material.

The piston is secured in the central channel of the housing and couples with the heat sensitive material by ways of a central area of the diaphragm, such that when the heat sensitive material expands at high temperature or contracts at low temperature, the piston is driven by the central area of the diaphragm to move in the central channel of the housing.

The metal casing further includes a metal structural body formed in the chamber, and the metal structural body has metal powders and cavities which communicate with one another; and wherein the metal powders are connected with one another, a part of the metal powders around a peripheral side of the metal casing are joined with an inner wall surface of the metal casing; wherein the cavities are defined among the metal powders, the inner wall surface of the metal casing, and each gap between any adjacent two of the metal powders.

The heat sensitive material is fluidic and is filled into the cavities of the metal casing.

A manufacturing method for a thermostatic assembly provided by the present invention contains steps of:

S1. preparing a metal casing, wherein the metal casing is soaked in fluid, and the metal casing includes a tubular section, a bottom segment for closing the tubular section, an accommodating portion extending outwardly from a top end of the tubular section, and a chamber defined between the tubular section and the bottom segment;

S2. filing metal powders, wherein the metal powders are granular and are filled into the chamber of the metal casing;

S3. sintering at a high temperature in a predetermined time, wherein the metal casing and the metal powder in the chamber are sintered at the high temperature, the metal powders are connected with one another, a part of the metal powders around a peripheral side of the metal casing are melted with an inner wall surface of the metal casing to form a metal structural body, and cavities are defined among the metal powders, the inner wall surface of the metal casing, and each gap between any adjacent two of the metal powders; and

S4. filling heat sensitive material, wherein the heat sensitive material is fluid and is fed into the chamber of the metal casing, thus filling the cavities fully and forming a combination of the metal casing and the thermal reaction material.

### BRIEF DESCRIPTION OF THE DRAWINGS

FIG. 1 is a cross sectional view of a conventional thermostatic assembly.

FIG. 2 is a cross sectional view taken along the lines 1-1 of FIG. 1.

FIG. 3 is another cross sectional view of the conventional thermostatic assembly.

FIG. 4 is a cross sectional view taken along the lines 2-2 of FIG. 3.

FIG. 5 is a perspective view showing the assembly of a thermostatic assembly according to a preferred embodiment of the present invention.

FIG. 6 is a plan view showing the exploded components of the thermostatic assembly according to the preferred embodiment of the present invention.

FIG. 7 is a cross sectional view showing the assembly of the thermostatic assembly according to the preferred embodiment of the present invention.

FIG. 8 is an amplified cross sectional view of a portion A of FIG. 7.

FIG. 9 is a flow chart of a manufacturing method for a thermostatic assembly according to a preferred embodiment of the present invention.

### DETAILED DESCRIPTION OF THE PREFERRED EMBODIMENTS

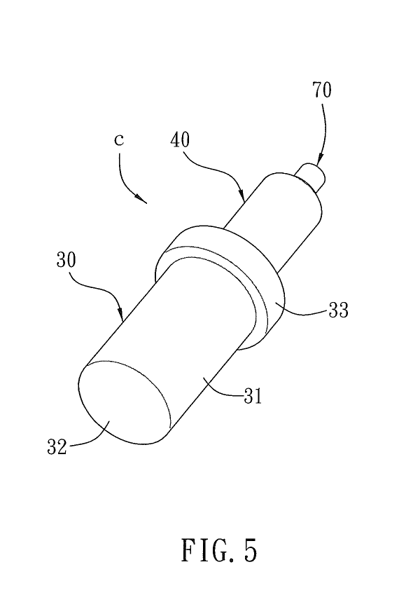

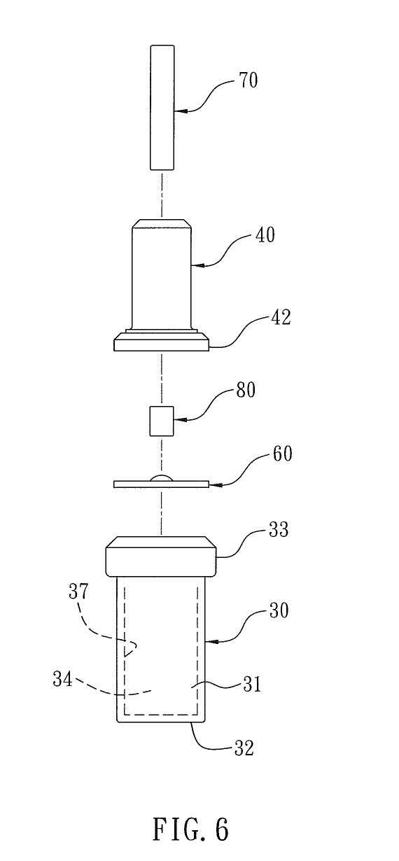

With reference to FIGS. 5-8, a thermostatic assembly according to a preferred embodiment of the present invention is installed in a thermostatic controlling device or a thermostatic control valve of shower equipment and comprises:

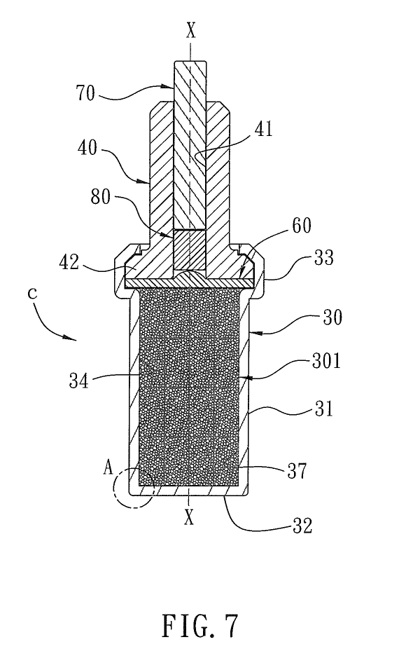

a metal casing 30 soaked in a fluid, such as water, as shown in FIG. 7, and the metal casing 30 including a tubular section 31, a bottom segment 32 for closing the tubular section 31, and an accommodating portion 33 extending outwardly from a top end of the tubular section 31; wherein between the tubular section 31 and the bottom segment 32 is defined a chamber 34;

a housing 40 including a central channel 41 and a seat 42 located at a bottom end thereof; wherein the seat 42 is fixed in the accommodating portion 33 of the metal casing 30;

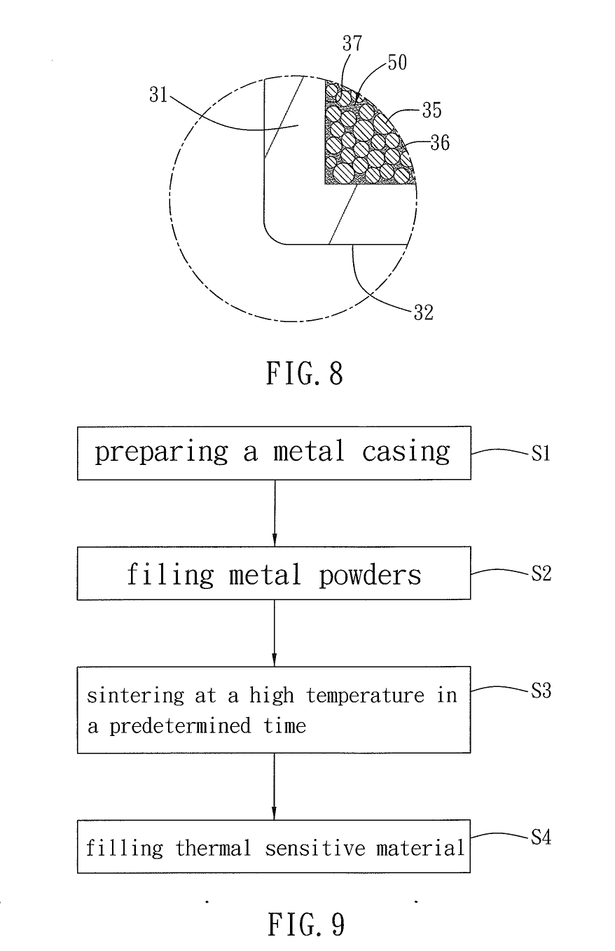

a heat sensitive material 50, as illustrated in FIG. 8, filled in the metal casing 30 and expanding and contracting based on a mixed temperature of cold water and hot water, wherein the heat sensitive material 50 is a thermal expansion material, such as paraffin wax, or the heat sensitive material 50 is a mixture of the thermal expansion material and thermal conduction powders, such as copper powders;

a diaphragm 60 disposed between the housing 40 and the metal casing 30 to separate the housing 40 from the heat sensitive material 50;

a piston 70 secured in the central channel 41 of the housing 40 and coupling with the heat sensitive material 50 by ways of a central area of the diaphragm 60, such that when the heat sensitive material 50 expands at high temperature or contracts at low temperature, the piston 70 is driven by the central area of the diaphragm 60 to move in the central channel 41 of the housing 40 along an axial line X-X of the thermostatic assembly;

a rubber pad 80 fixed in the central channel 41 of the housing 40 and located between the piston 70 and the diaphragm 60 so that the central area of the diaphragm 60 drives the piston 70 via the rubber pad 80, wherein the rubber pad 80 is made of a deformable elastomer.

An improvement of the thermostatic assembly of the present invention comprises:

the metal casing 30 further including a metal structural body 301, as shown in FIGS. 7 and 8, wherein the metal structural body 301 has metal powders 35 and cavities 36 which communicate with one another; and wherein the metal powders 35 are connected with one another, a part of the metal powders 35 around a peripheral side of the metal casing 30 are joined with an inner wall surface 37 of the metal casing 30; wherein the cavities 36 are defined among the metal powders 35, the inner wall surface 37 of the metal casing 30, and each gap between any adjacent two of the metal powders 35;

the heat sensitive material 50 is fluidic and is filled into the cavities 36 of the metal casing 30.

The metal powders 35 are copper powders or sliver powders. In this embodiment, the metal powders 35 are copper powders among which large friction resistance exists, such that the metal powders 35 cannot pile up, and the heat sensitive material 50 are paraffin wax. Under text, we can find a volume of the copper powders accounts 30% of total capacity in the chamber 34 of the metal casing 30, wherein a preferred volume of the copper powders is within 20% to 40%, and a volume of the heat sensitive material 50 is 60% to 80%.

Preferably, each of the metal powders 35 is granular.

Referring to FIG. 9, a manufacturing method for a thermostatic assembly according to a preferred embodiment of the present invention comprises steps of:

S1. preparing a metal casing 30, wherein the metal casing 30 is soaked in a fluid, and the metal casing 30 includes a tubular section 31, a bottom segment 32 for closing the tubular section 31, an accommodating portion 33 extending outwardly from a top end of the tubular section 31, and a chamber 34 defined between the tubular section and the bottom segment;

S2. filing metal powders 35, wherein the metal powders are copper powders and are filled into the chamber 34 of the metal casing 30;

S3. sintering at a high temperature in a predetermined time, wherein the metal casing 30 and the metal powder 35 in the chamber 34 are sintered at the high temperature, the high temperature is 950° C., and the predetermined time is 1 hour, such that the metal powders 35 are connected with one another, and a part of the metal powders 35 around a peripheral side of the metal casing 30 are melted with an inner wall surface 37 of the metal casing 30 to form a metal structural body 301, and cavities 36 are defined among the metal powders 35, the inner wall surface 37 of the metal casing 30, and each gap between any adjacent two of the metal powders 35; and

S4. filling heat sensitive material 50, wherein the heat sensitive material 50 is fluidic, i.e., the heat sensitive material 50 is paraffin wax, to be fed into the chamber 34 of the metal casing 30, thus filling the cavities 36 fully and forming a combination of the metal casing 30 and the thermal reaction material 50.

The thermostatic assembly c of the present invention is used to sense an external fluid medium, such as the mixed temperature of the cold water and the hot water, and the metal casing 30 and the heat sensitive material 50 are applied to conduct heat. For example, after the thermostatic assembly c is connected with the thermostatic controlling device or the thermostatic control valve, and the mixed temperature of the cold water and the hot water increases, the heat sensitive material 50 expands because of heat conduction, and the piston 70 is driven by the diaphragm 60 and the rubber pad 80 to extend outwardly so as to further drive a valve block, hence a first inlet for flowing the hot water is reduced, a second inlet for flowing the cold water is increased, and a mixed ratio of the hot water and the cold water is lowered to decrease the mixed temperature. In contrast, when the mixed temperature reduces, the heat sensitive material 50 contracts because of the heat conduction, and the rubber pad 80 and the piston 70 are driven by the diaphragm 60 and a return spring for matching with the diaphragm 60 to retract inwardly, such that the valve block is driven by the rubber pad 80 and the piston 70, the first inlet for flowing the hot water is increased, the second inlet for flowing the cold water is reduced, and the mixed ratio of the hot water and the cold water is raised to increase the mixed temperature. Because above-mentioned operation and technique are well-known, only a brief description is shown herein.

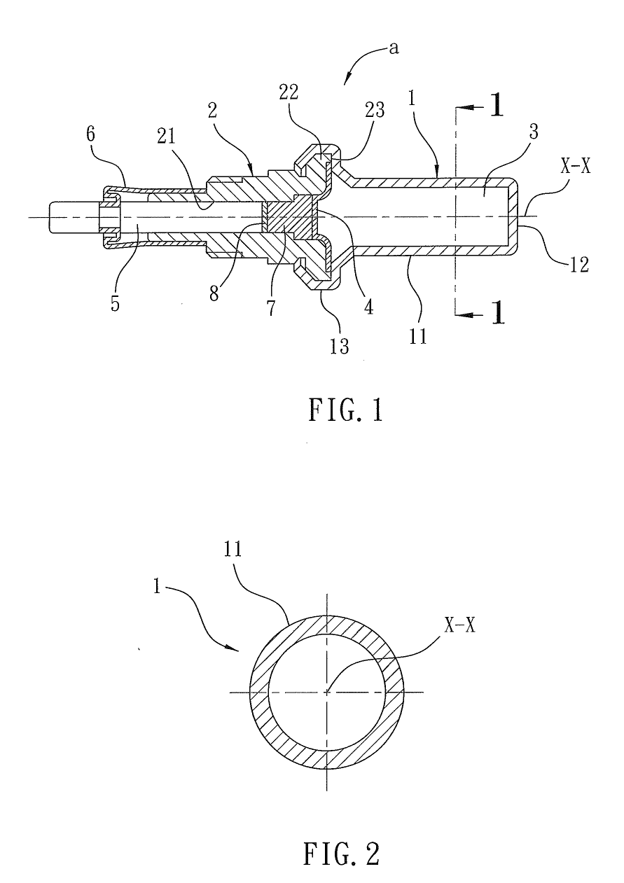

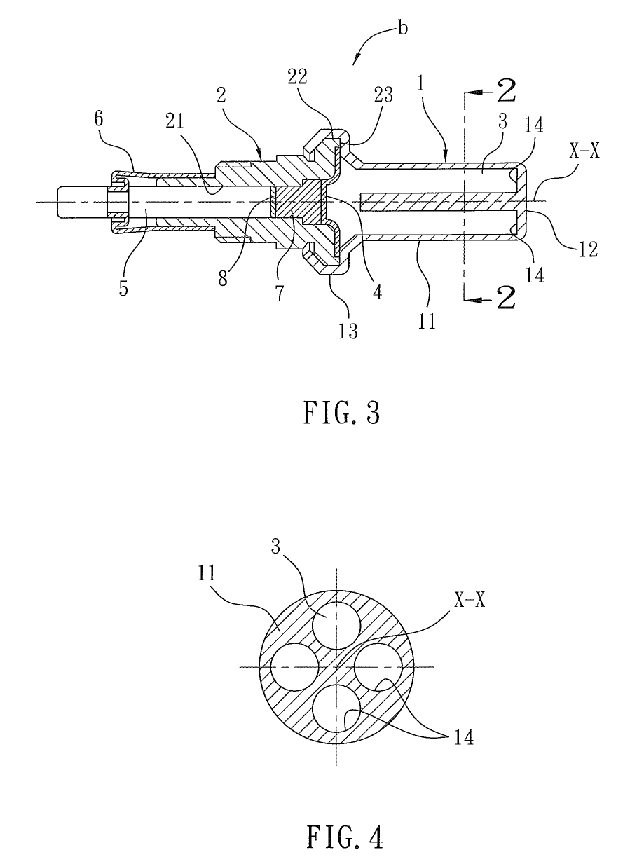

It is to be noted that the thermostatic assembly c not only enables an external fluid to flow through an outer surface of the metal casing 30, as shown in FIG. 8, but also allows a heat of the external fluid conducting through the metal structural body 301 from the metal casing 30. Preferably, the part of the metal powders 35 around the peripheral side of the metal casing 30 are joined with the inner wall surface 37 of the metal casing 30 to conduct heat toward the heat sensitive material 50 in the cavities 36 quickly, such that the heat sensitive material 50 expands at the high temperature and contracts at the low temperature to reduce a reaction time of the piston 70 greatly (i.e., to decrease a reaction time of the thermostatic assembly c). By an experiment, the heat conducting efficiency of the thermostatic assembly c is enhanced 2 to 2.7 times more than that of the conventional thermostatic assembly as shown in FIGS. 1 and 2. Likewise, the heat conducting efficiency of the thermostatic assembly of the present invention is enhanced 1.3 to 1.5 times more than that of the conventional thermostatic assembly as shown in FIGS. 3 and 4.

The heat sensitive material 50 of the thermostatic assembly c is decreased, and the heat conducting efficiency of the thermostatic assembly c is increased greatly, because a heat of the fluid conducts toward the metal powders 35 in the chamber 34 through the metal casing 30 to increase a contacting area among the heat sensitive material 50, the metal casing 30, and the metal powders 35, thus enhancing a heat conductivity to shorten the reaction time of the piston 70.

The metal powders 35 are connected with one another, the part of the metal powders 35 around the peripheral side of the metal casing 30 are joined with the inner wall surface 37 of the metal casing 30 to form the metal structural body 301, so the metal structural body 301 does not cause separated deposition of the copper powders, and the heat sensitive material 50 expands at the high temperature and contracts at the low temperature, thus prolonging a service life of the thermostatic assembly of the present invention.

While the preferred embodiments of the invention have been set forth for the purpose of disclosure, modifications of the disclosure embodiments of the invention as well as other embodiments thereof may occur to those skilled in the art. The scope of the claims should not be limited by the preferred embodiments set forth in the examples, but should be given the broadest interpretation consistent with the description as a whole.

1. A thermostatic assembly comprising:
a metal casing soaked in a fluid, and the metal casing including a tubular section, a bottom segment for closing the tubular section, and an accommodating portion extending outwardly from a top end of the tubular section; wherein between the tubular section and the bottom segment is defined a chamber;
a housing including a central channel and a seat located at a bottom end thereof; wherein the seat is fixed in the accommodating portion of the metal casing;
a heat sensitive material filled in the chamber of the metal casing and expanding and contracting based on a mixed temperature of cold water and hot water;
a diaphragm disposed between the housing and the metal casing to separate the housing from the heat sensitive material;
a piston secured in the central channel of the housing and coupling with the heat sensitive material by ways of a central area of the diaphragm, such that when the heat sensitive material expands at high temperature or contracts at low temperature, the piston is driven by the central area of the diaphragm to move in the central channel of the housing;
wherein the metal casing further includes a metal structural body formed in the chamber, and the metal structural body has metal powders and cavities which communicate with one another; and wherein the metal powders are connected with one another, a part of the metal powders around a peripheral side of the metal casing are joined with an inner wall surface of the metal casing; wherein the cavities are defined among the metal powders, the inner wall surface of the metal casing, and each gap between any adjacent two of the metal powders;
wherein the heat sensitive material is fluidic and is filled into the cavities of the metal casing.

2. The thermostatic assembly as claimed in claim 1, wherein the metal powders are copper powders.

3. The thermostatic assembly as claimed in claim 1, wherein the heat sensitive material is paraffin wax.

4. The thermostatic assembly as claimed in claim 1, wherein a part of the metal powders around a peripheral side of the metal casing are joined with the inner wall surface of the metal casing in step of sintering at a high temperature in a predetermined time to form the metal structural body.

5. The thermostatic assembly as claimed in claim 4, wherein the high temperature is 950° C., and the predetermined time is 1 hour.

6. The thermostatic assembly as claimed in claim 1 further comprising a rubber pad fixed in the central channel of the housing and located between the piston and the diaphragm so that the central area of the diaphragm drives the piston via the rubber pad.

7. The thermostatic assembly as claimed in claim 1, wherein a volume of the copper powders is within 20% to 40%.

8. The thermostatic assembly as claimed in claim 1, wherein each of the metal powders is granular.

9. A manufacturing method for a thermostatic assembly comprising steps of:
S1. preparing a metal casing, wherein the metal casing is soaked in fluid, and the metal casing includes a tubular section, a bottom segment for closing the tubular section, an accommodating portion extending outwardly from a top end of the tubular section, and a chamber defined between the tubular section and the bottom segment;
S2. filing metal powders, wherein the metal powders are granular and are filled into the chamber of the metal casing;
S3. sintering at a high temperature in a predetermined time, wherein the metal casing and the metal powder in the chamber are sintered at the high temperature, the metal powders are connected with one another, a part of the metal powders around a peripheral side of the metal casing are melted with an inner wall surface of the metal casing to form a metal structural body, and cavities are defined among the metal powders, the inner wall surface of the metal casing, and each gap between any adjacent two of the metal powders; and
S4. filling heat sensitive material, wherein the heat sensitive material is fluid and is fed into the chamber of the metal casing, thus filling the cavities fully and forming a combination of the metal casing and the thermal reaction material.

10. The manufacturing method for the thermostatic assembly as claimed in claim 9, wherein in the step of S2, the metal powders are copper powders.

11. The manufacturing method for the thermostatic assembly in claim 9, wherein in the step of S3, the high temperature is 950° C., and the predetermined time is 1 hour.

12. The manufacturing method for the thermostatic assembly as claimed in claim 9, wherein in the step of S4, the heat sensitive material is paraffin wax.
